(19) United States
(12) Patent Application Publication
(10) Pub. No.: US 2025/0110494 A1
(43) Pub. Date: Apr. 3, 2025

(54) METHOD AND SYSTEM FOR VERIFYING A FIELD DEVICE FUNCTION

(71) Applicant: KROHNE Messtechnik GmbH, Duisburg (DE)

(72) Inventors: Dirk KUSCHNERUS, Krefeld (DE); Christian WALLAU, Buchholz (DE)

(21) Appl. No.: 18/894,777

(22) Filed: Sep. 24, 2024

(30) Foreign Application Priority Data
Sep. 28, 2023 (EP) 23 200 577.7

(51) Int. Cl. G05B 23/02

(52) U.S. Cl. CPC G05B 23/0262; G05B 23/0275

(57) ABSTRACT

The present invention relates to a method for verifying a field device function of a field device, wherein the field device forms verification information, in particular a device status and/or current measured values, with which the field device function is verifiable, wherein a coupling takes place between a mobile terminal device and the field device, as a result of which a wireless data connection is set up between the field device and the terminal device, wherein the verification information is transmitted via the data connection from the field device and the field device function of the field device is verified with the verification information, wherein the coupling takes place fully automatically when the terminal device reaches or enters a reception range of the field device, and wherein the verification information is transmitted fully automatically from the field device via the wireless data connection.

### CROSS-REFERENCE TO RELATED APPLICATIONS

This application claims the benefit under 35 U.S.C. 119 (a) to European Patent Application No. 23 200 577.7, filed Sep. 28, 2023, the disclosure of which is incorporated herein by reference in its entirety.

### BACKGROUND

The present invention relates to the verification of a field device function of a field device.

Particularly preferably, the present invention relates to process engineering installations, plants and/or systems of the chemical industry, food industry and the manufacturing industry. However, in principle, it is also applicable and advantageous in other fields.

The plant safety requires measuring devices in use as field devices to be regularly checked for correct function and in this way to verify the field device function. For this purpose, data and error reports can be read out and testing methods can be carried out.

Often, a large number of field devices are arranged in a plant, installation and/or system. Due to the preferably permanent use of the field devices, it is regularly provided that a proper field device function of the respective field device is verified without dismantling, disassembling and/or dismounting the field device.

In order to verify the field device function, the field device forms verification information. The verification information may comprise a device status and/or measured values of the field device or be formed thereby. For verification, it is provided that a coupling takes place between a mobile terminal device (also referred to below only as terminal device) and the field device. By means of the coupling, a wireless data connection is set up or established between the field device and the terminal device. The verification information is formed in the field device, transmitted and the field device function of the field device can be verified with and/or based on the verification information after transmission of the verification information.

In the case of known verifications, it is necessary that a user moves the terminal device into the vicinity of the field device and connects the terminal device to the field device by manual intervention, namely selection of the desired field device and input of a command for coupling (manual pairing). For this purpose, the user has knowledge of a requirement for the verification of certain field devices and controls the forming of the verification information via a user interface of the terminal device, which has proven to be time-consuming and thus expensive overall.

The procedure for verification known from the prior art is also disadvantageous in that the manual user guidance stands in the way of a close or frequent verification due to the considerable effort and binding of personnel resources.

### SUMMARY OF THE INVENTION

Against this background, it is an object of the present invention to provide a method, a system and a computer program product, with which the verification effort can be reduced and an improved operational safety can be realized.

This object is achieved by a method, by a system or by a storage medium comprising a computer program product as described herein.

In the proposed method, the coupling takes place fully automatically (automated pairing) when the terminal device reaches or enters a reception range of the field device. Preferably, a monitoring takes place and, upon detection of a couplable/pairable field device and/or terminal device, the steps necessary for the coupling/pairing are automatically initiated.

In contrast to processes running in the foreground, which require an interaction and for this purpose occupy and use input resources and output resources, the steps of the proposed method realized by the terminal device are preferably effected/performed as a background process, i.e. without interaction with a user and/or without occupying or using input resources and output resources.

Furthermore, the verification information is transmitted fully automatically from the field device via the wireless data connection (formed/established during the coupling/pairing). The transmission can be initiated by the terminal device or by the coupling.

The verification with automatic coupling and transmission of the verification information can also be referred to as passive verification, since the verification is preferably performed freely or independently of user interventions.

The initiation of the coupling process triggered by a detection that the terminal device is in the reception range of the field device advantageously leads to the coupling and the transmission of the verification information taking place fully automatically, i.e. avoiding any manual user intervention.

In particular, the coupling and further, preferably all, steps up to the verification on the basis of the verification information is/are one or more background activities. These can take place automatically with the screen locked, with other operating elements of the terminal device locked, while other applications are executed and displayed on the terminal device and/or independently of any user interventions on the terminal device.

The described automation of the coupling and transmission of the verification information advantageously leads to a verification being able to be carried out overall without user intervention. Consequently, the mobile terminal device merely needs to be moved relative to the field devices without user intervention in the region of a plant, installation or system comprising the field device(s). This is because in this way the mobile terminal device successively reaches or enters reception ranges of the field devices and these can correspondingly be verified fully automatically without user intervention, preferably much more often than would be practicable with manual verification.

It is preferred that the mobile terminal device is carried along by employees or forms part of a vehicle and in this way occasionally enters the reception range of the field device(s). In this way, it can be ensured that a verification of the (respective) field device can take place statistically at least often enough and in particular much more often than necessary or than previously usual, as a result of which the operational safety can ultimately be significantly improved.

This enables a closer or more frequent monitoring of the field devices and a prediction of the failure probability or breakdown probability and thus of the state of the plant or installation or system. As a result, the risk of a failure or breakdown of a plant/installation/system or of parts thereof can be significantly reduced in a synergistic manner, which leads to an improved operational safety, while the need for personnel resources for the verification even decreases in comparison with the more coarse or less frequent manual verification.

It is understood that, regardless of the fully automatic procedure within the meaning of the present invention, a manually initiated verification can be carried out additionally as required. In particular, statistics are kept about verifications which have been carried out and a manual verification is initiated, should, contrary to expectations, the fully automatic coupling and transmission of the verification information not take place in time. For this purpose, a signal and/or an instruction can be output, for example via the mobile terminal device. The mobile terminal device can be configured additionally as required via a user interface for manually carrying out the steps necessary for the verification, which user interface is not used for the automatic verification, however.

The verification and/or a self-test of the field device underlying this verification can be carried out or supported in different gradations. For example, the verification and/or the underlying self-test of the field device can be carried out in different levels:
Level 0: verification with ongoing measurement without separation of measuring transducer and sensor
Level 1: verification without separation of measuring transducer and sensor, additional interruption of the measurement operation by simulation of measured values
Level 2: verification with separation of sensor and measuring transducer/by physical feeding in of measurement signals

In other words, a connection between a measuring transducer and a sensor of the field device preferably remains uninterrupted during the verification. The verification preferably takes place with ongoing measurement without separation of measuring transducer and sensor. The verification under this prerequisite/condition is henceforth also referred to as “Level 0” verification. Alternatively or additionally, the verification can also be carried out without separation of measuring transducer and sensor, wherein the measurement operation is interrupted, however, and, if necessary, measured values are simulated or otherwise substituted in the meantime. The verification under this prerequisite/condition is henceforth also referred to as “Level 1” verification. The control of the level or levels or gradations of a different kind can take place (fully) automatically by the field device and/or by the terminal device.

In principle, it is alternatively or additionally possible to operate the system and/or the plant/installation temporarily with disassembled or demounted measuring transducer, for example with physical feeding in of measurement signals, in order to separately check the measuring transducer for its function and to use the result as a basis for the verification of the field device function. Preferably, however, a physical change to the field device and/or to the plant/installation/system is avoided for the verification of the field device function, thus in particular the connection of the measuring transducer to the sensor of the field device is maintained.

The present invention is explained below on the basis of one field device and one terminal device and can in principle also be realized with only one field device and only one terminal device. However, it is understood that the present invention can be scaled. In particular, the proposed verification of multiple field devices in succession with the same or different terminal devices is particularly advantageous. Alternatively or additionally, the proposed verification of multiple field devices simultaneously with the same or different terminal devices can be particularly advantageous. Thus, a simultaneous coupling or couplability (coupling capability) of the same terminal device to multiple field devices for the purpose of simultaneous verification can be provided. The features of the present invention explained with regard to the one terminal device and the one field device are correspondingly applicable to multiple field devices, terminal devices and couplings/pairings and are particularly advantageous in this case, in particular since the advantages are particularly evident in connection with systems, plants or installations which have multiple field devices.

A further aspect of the present invention relates to a system for carrying out the proposed method, which system thus comprises one or more field devices and at least one mobile terminal device and is configured such that the coupling or pairing between the terminal device and the field device takes place fully automatically when the terminal device reaches or enters the reception range of the field device, and such that the verification information is transmitted fully automatically from the field device via the wireless data connection.

The proposed system is in particular a process engineering plant or installation having numerous field devices and at least one, preferably multiple, mobile terminal devices. A movement of the terminal device(s) through or along the system, plant or installation thus advantageously enables the verification effort to be reduced and the increased operational safety to be realized. This is because, with the proposed system, a verification can be achieved statistically sufficiently often and practically much more often than mandatory.

A further aspect of the present invention, which can also be realized independently, relates to a computer program or computer program product comprising program code or program code means—in particular stored on a non-transient storage medium-which, when executed on processors of the field device(s) and of the terminal device(s), cause the proposed method to be carried out.

The computer program or computer program product offers the advantage of a simple implementation and, where applicable, practicable retrofitability of existing process engineering plants, installations and systems therewith for carrying out the proposed method.

A field device within the meaning of the present invention is preferably a measuring device or an apparatus comprising a measuring device for preferably permanent and/or localized/stationary use in a plant/installation/system, for example in the chemical industry, food industry and/or manufacturing industry.

Particularly preferably, a field device within the meaning of the present invention is a measuring device for instrumentation, such as a flow measuring device, a flow control device, a fill level measuring device, a temperature measuring device, a pressure measuring device, a process analysis device or the like.

The field device within the meaning of the present invention can alternatively or additionally be an actuator, preferably with a corresponding measuring device, which can serve in particular for the purpose of a self-test, self-monitoring and/or diagnosis.

A field device function within the meaning of the present invention is (at least primarily) a measurement or comprises the measurement or suitability for measurement, in particular according to a specification. Preferably, the field device function comprises the measurement of one or more measurement results corresponding to the type of the respective field device. For this purpose, the measurement results can be measured by/with the sensor of the field device. The measurement results can be or comprise parameters. The measurement results represent in particular a flow rate, a fill level, a temperature, a pressure, an analysis result or the like. Alternatively or additionally, the field device function can also be or comprise an operation of the actuator.

However, the field device function can also comprise other functions in addition to the measurement. For example, the field device function can comprise a conversion and/or output of the measurement result determined by the measurement. Alternatively or additionally, the field device function can comprise a warning, a determination of one or more supplementary measured values and/or a determination of information on the operating state of the field device or of the plant, installation or system.

A verification within the meaning of the present invention is preferably the checking of the verification information for confirmation of the field device function or recognition of a defect (lack of field device function, in particular malfunction such as measurement accuracy or lack of functionality) of the field device, and/or the recognition of an indicator for an imminent defect (prediction/forecast of a defect) of the field device. The latter advantageously enables a replacement or a repair/maintenance of the field device to be carried out during a later, regular maintenance/servicing of the plant or installation or system comprising the field device, so that unplanned disturbances/disruptions of its operation can be effectively avoided.

For or during the verification, a status of a device can be read out and/or transmitted as verification information. This can take place e.g. based on the NAMUR recommendation NE 107:2017-04-10 “Selbstüberwachung und Diagnose von Feldgeräten” (Self-monitoring and diagnosis of field devices), Beuth-Verlag, 2017 or other common industry standards/industry recommendations.

Thus, the verification information can enable the determination of a failure/breakdown, a requirement for a functional control, an operation outside the specification, and/or a maintenance requirement as verification result. The determination can be or comprise an interpretation of the verification information with further analysis or without further analysis of the verification information.

In order to form the verification information, components of the field device can be checked for functionality, in particular an electronics system, a sensor element, an actuator element, one or more mechanical components and/or a means for supplying energy to the field device, wherein the verification information then comprises the result of the checking or is formed thereby.

After or prompted by the verification, the verification result may be output, such as automatic notifications and/or warnings, e.g. in the form of a warning tone, a corresponding message or a similar measure drawing attention to a situation corresponding to the status.

For example, measurement deviations at the edge of or beyond a predefined tolerance range can form an indicator for an imminent or upcoming defect. Alternatively or additionally, a prediction/forecast of measurement deviations, for example over a time series, can form such an indicator for an imminent or upcoming defect. However, other indicators are also possible which directly or indirectly indicate an imminent or upcoming defect.

Due to the closer or more frequent verification which the present invention enables, a safer and/or earlier detection of defects or potential defects results and thus enables the avoidance of disturbances/disruptions and damages resulting therefrom.

Verification information within the meaning of the present invention preferably comprises raw data which enable a conclusion to be drawn about the (proper) field device function. The field device function is thus verifiable with the verification information and in particular the raw data.

The verification information and/or the raw data can be parameters relating to the function of the field device, results of a self-test, self-monitoring and/or diagnosis, results of a calibration measurement, and/or one or more status and/or error reports. The verification information comprises in particular a device status and/or (current) measured values of the field device. However, the verification information can alternatively or additionally also contain other information. For example, in addition to the raw data characterizing the field device function, the verification information can comprise a time stamp assigned thereto and/or a field device ID for identifying the field device.

By means of the self-test and/or self-monitoring and/or diagnosis, field devices can determine and/or form information about their state as verification information. The verification information can be suitable for checking the plausibility of a measured value of a sensor and/or of the functionality of the actuator of the (respective) field device and thereby verifying the function of the (respective) field device. In an advantageous manner, negative influences on a function of the plant or installation or system comprising the field device(s) by a breakdown of field instrumentation can thus be avoided.

The verification information can be used in the planning of plant/installation/system shutdowns and the like. As a result, the present invention enables, as required, planned maintenance measures to be at least partially omitted and, instead, to carry out maintenance measures in a state-oriented manner, which are correspondingly more appropriate to requirements and/or enable a reduction of downtimes.

The mobile terminal device within the meaning of the present invention is particularly preferably a smartphone (mobile phone/cell phone), tablet computer, wearable device, in particular smartwatch, or another portable device. The mobile terminal device is preferably equipped for network-independent operation, in particular is thus supplied with electrical energy by an energy store such as a battery or a rechargeable battery. The mobile terminal device is preferably portable.

The mobile terminal device is preferably couplable to or pairable with one or more field devices, whereby a wireless connection is set up or established between the (respective) field device and the terminal device. For this purpose, the mobile terminal device preferably comprises a processor and/or an application for carrying out the proposed method and/or a transceiver for coupling/pairing and establishing the wireless data connection. It may comprise a user interface, wherein the proposed method preferably does not require any user inputs, however.

A coupling within the meaning of the present invention may be or comprise a so-called pairing, i.e. the setting up of a data connection and in particular a point-to-point data connection. The coupling can take place with a transmission standard which is suitable and/or usual in particular for ad-hoc connections. Particularly preferably, it is a WLAN, WPAN and/or NFC coupling, for example by Bluetooth and preferably according to the Bluetooth Low Energy (BLE) standard. In principle, however, the coupling and/or wireless data connection can also be realized with other methods and/or standards.

Preferably, the verification information is transmitted from the field device to the terminal device via the data connection and is used either by the terminal device itself or by an external application for forming a verification result.

A verification result within the meaning of the present invention can be or form an indicator for a specification-compliant or non-specification-compliant function (defect) of the field device. Alternatively or additionally, the verification result can be or comprise details about the function such as an accuracy information or tolerance information. Very particularly preferably, the verification result comprises a prediction or forecast about the specification-compliant or non-specification-compliant function of the field device and/or a recommendation for action relating to the field device.

Preferably, the verification information is transmitted directly or indirectly to the external application via the terminal device or also via another data connection. The external application is preferably a process which is executed or executable on a server and/or in the (Internet) cloud. The external application is preferably realized structurally/spatially separately from the terminal device. However, the function(s) of the external application can also be realized in the terminal device. The external application may be or form a data platform.

The verification information can be received and evaluated by the external application, so that the external application forms the verification result. Alternatively or additionally, the application can receive, further process, evaluate, store and/or aggregate into a time series the verification result formed by evaluation of the verification information. If required, this can be initiated by the mobile terminal device. Optionally, the external application provides information for checking a verification requirement, with which it can be checked whether a verification of the respective field device should be performed at the present point in time. The external application can optionally manage multiple field devices of a system, plant or installation. However, the management can also take place in another way and the application can also comprise multiple modules for different functions, which can be executed at different locations. The application can centrally provide its functions for multiple or all mobile terminal devices.

A reception range within the meaning of the present invention is preferably a zone starting/originating from the (respective) field device, which zone extends up to a distance from the (respective) field device, up to which the coupling can take place, for example, with the terminal device and/or up to which the data connection can be set up. The reception range can be formed and/or influenced by a transceiver and/or an antenna of the field device.

In the present invention, it is referred to the reception range of the (respective) field device in favor of clarity and conciseness. Regardless of this, the reception range can be or become influenced by the terminal device, in particular by the transmission and/or reception properties of the terminal device. Thus, an extended or reduced reception range may occur if the transmission and/or reception properties of the terminal device are better or worse. Thus, the term “reception range of the field device” can therefore be understood to mean a range jointly influenced by the combination of the field device with the terminal device, in which range the coupling is possible, or said term can be replaced thereby.

Further advantages, properties and aspects of the present invention result from the claims and the following description of preferred exemplary embodiments with reference to the accompanying drawings.

### BRIEF DESCRIPTION OF THE DRAWINGS

FIG. 1 shows a simplified schematic view of a proposed system; and

FIG. 2 shows a schematic sequence diagram of a proposed verification.

### DETAILED DESCRIPTION

In the figures, the same reference signs are used for identical or similar parts, wherein corresponding or similar properties and advantages can be achieved, even if a repeated description is dispensed with.

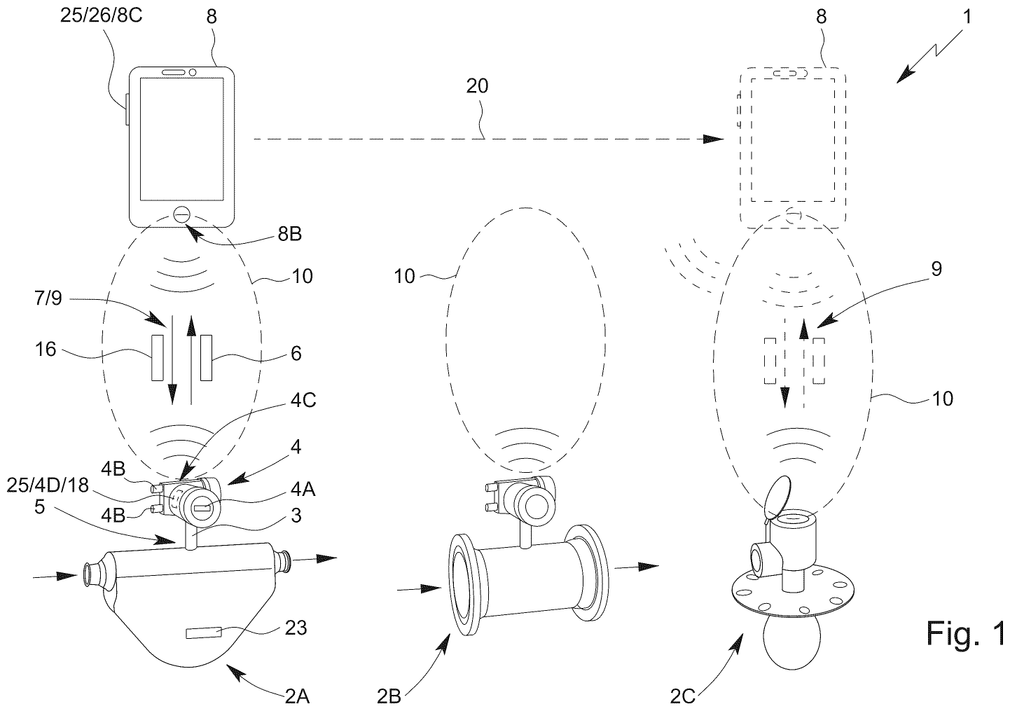

FIG. 1 shows a proposed system 1 in a simplified schematic view. The system 1 comprises at least one field device 2A, 2B, 2C.

In the illustrative example, the system 1 comprises three field devices 2A, 2B, 2C. However, more or fewer or other field devices 2A, 2B, 2C may also be provided. The respective field devices 2A, 2B, 2C may have the same or different field device functions. They preferably form parts of a common, preferably process engineering, plant or installation.

In the illustrative example according to FIG. 1, there is, by way of example, a first, preferably Coriolis-effect-based, flow measuring device or flowmeter 2A, a second, preferably ultrasound-based, flow measuring device or flowmeter 2B and a third, preferably radar-based, fill level measuring device or level gauge 2C. However, the present invention is also advantageous with other field devices, so that the indicated field device types merely represent examples.

The field devices 2A, 2B, 2C preferably each have a connection 3 between a measuring transducer 4 and a sensor 5. The respective field devices 2A, 2B, 2C may have different sensors 5.

The sensor 5 is preferably configured to measure one or more physical and/or chemical variables, preferably process variables, in particular a flow (rate), a fill level, a pressure, a temperature and/or one or more physical and/or chemical properties of a medium and/or for liquid analysis.

The invention is particularly advantageous when used in process engineering, in particular in the operation and monitoring of wide-ranging process engineering plants or installations having a plurality of field devices 2A, 2B, 2C. However, the present invention is preferably not limited thereto, so that the sensor 5 may also measure variables other than the indicated variables and the present invention may also be advantageous in this case.

The measuring transducer 4 preferably forms an interface between the sensor 5 and the periphery, such as a plant control or system control. In particular, it may convert the physical and/or chemical variables directly measured by the sensor 5 into measurement data and/or into parameters as measurement results, which preferably correspond to the physical and/or chemical variables or are derived therefrom.

The measuring transducer 4 may comprise a display means 4A for displaying the measurement results or an operating state of the field device 2A, 2B, 2C. Alternatively or additionally, the measuring transducer 4 comprises a preferably wired interface 4B, which is configured to output the measurement results determined by the sensor 5.

The measuring transducer 4 preferably comprises a radio interface 4C, via which the verification of the field device function, in particular of the measurement accuracy or the defect recognition, can be carried out. This radio interface 4C is preferably a transceiver, which is operated with a data transmission protocol, for example Bluetooth, in particular Bluetooth LE (BLE), or another, for example WPAN, WLAN, or NFC protocol

The field devices 2A, 2B, 2C preferably form the verification information 6 automatically or upon corresponding command or are configured therefor.

Preferably, device-type-specific and possibly at least partially different (pieces of) verification information 6 is/are formed by different field devices 2A, 2B, 2C and/or evaluated during or for verification. Thus, depending on the device type or sensor 5 of the respective field device 2A, 2B, 2C, different requirements are preferably checked during the verification on the basis of the respective (piece of) verification information 6.

While the present invention is explained in more detail below by way of example on the basis of one of the field devices 2A, 2B, 2C, namely initially primarily on the basis of the field device 2A illustrated on the left in FIG. 1, the different field devices 2A, 2B, 2C preferably each also have the properties described by way of example on the basis of the field device 2A, unless explained otherwise or implicitly apparent. The primary function and/or the sensor 5 of the respective field device 2A, 2B, 2C may be different in nature, but the basic steps, properties and advantages of the proposed verification are preferably the same for the field devices 2A, 2B, 2C, so that a repeated description is omitted.

According to the proposal, the field device function of the first field device 2A is verified. For this purpose, the field device functions are checked on the basis of or using the verification information 6. For this purpose, the verification information 6 may comprise one or more operating parameters of the field device 2A and/or sensor 5 relating to the operation of the field device 2A and in particular self-test results (results preferably of one or more device-internal testing methods), which are checked. For checking, the verification information 6, thus in particular the operating parameters and/or self-test results, can be analyzed with regard to expected values, reference values, tolerance ranges, development trends, a specification and the like.

The verification is successful if no irregularities are identified during the checking. The verification fails if irregularities such as deviations from an expected value, reference value, tolerance value, a specification or the like are identified during the checking. A failed verification preferably leads to a signaling such as a notification or warning, for example by the terminal device 8 or another output means.

As schematically illustrated by way of example in FIG. 1, a pairing or coupling 7 takes place between a mobile terminal device 8 and the field device 2A, as a result of which a wireless data connection 9 is set up or established between the field device 2A and the terminal device 8.

The mobile terminal device 8 may comprise a display means 8A such as a display or screen, in particular a touchscreen. Alternatively or additionally, the mobile terminal device 8 comprises a radio interface 8B, via which the coupling 7 can take place. The radio interface 8B is preferably a transceiver, which is operated with a data transmission protocol, for example Bluetooth, in particular Bluetooth LE (BLE), or another, for example WPAN, WLAN, or NFC protocol.

The radio interface 8B of the mobile terminal device 8 preferably corresponds to the radio interface 4C of the field device 2A and/or of the measuring transducer 4. The radio interfaces 4C, 8B are configured to effect or produce the coupling 7. For this purpose, available coupling partners (ready-to-couple field device 2A and ready-to-couple mobile terminal device 8) can be identified in the reception range 10 and a coupling process can be started in order to set up or establish the wireless data connection 9.

The wireless data connection 9 is preferably a wireless point-to-point connection. An ad hoc network can be formed or extended by the coupling 7. However, other forms of the data connection 9 are also possible.

According to the proposal, the coupling 7 takes place fully automatically when the terminal device 8 reaches or enters a reception range 10 of the field device 2A. It may thus be provided that the terminal device 8 moves relative to the field device 2A—as indicated in FIG. 1 by the dashed arrow—and the terminal device 8 reaches or enters the reception range 10 of the field device 2A in the course of this movement 20.

After the wireless data connection 9 has been set up/established, the verification information 6 is transmitted via the wireless data connection 9 from the field device 2A and the field device function of the field device 2A is verified with the verification information 6.

In the illustrative example, the field device 2A forms the verification information 6 which is transmitted fully automatically from the field device 2A, preferably to or via the mobile terminal device 8, via the wireless data connection 9.

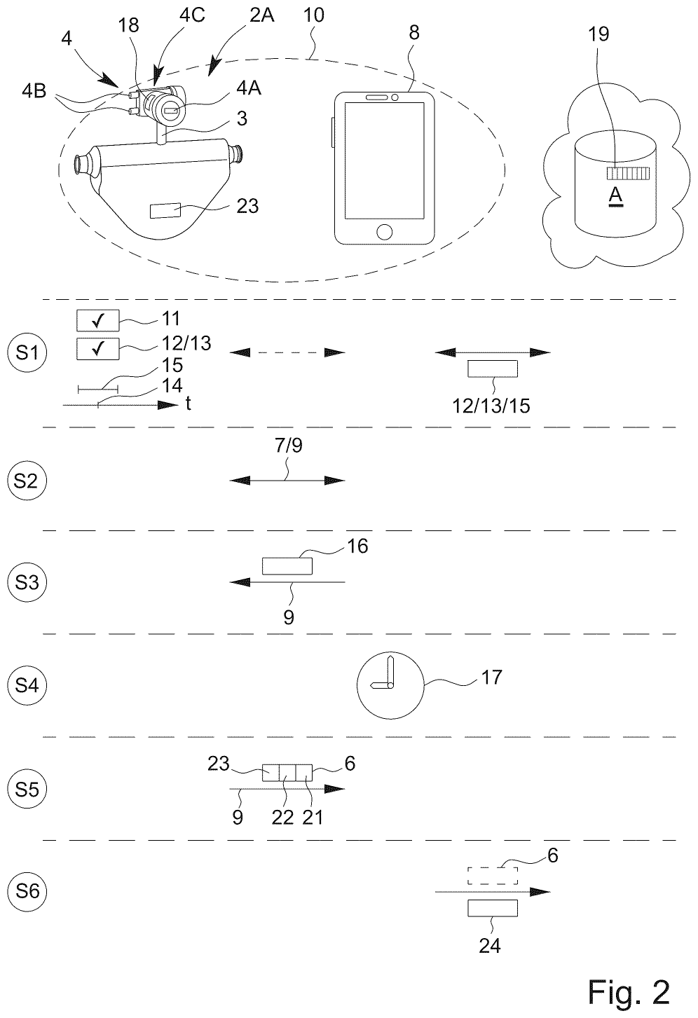

FIG. 2 shows a schematic sequence diagram of a proposed verification on the basis of chronologically successive steps S1 to S6. It is understood that it is possible in principle to omit one or more of the steps S1 to S6, to insert steps and/or to carry out only a subset of the steps S1 to S6, preferably while maintaining the sequence shown.

In a first step S1, it is preferably first probed whether a coupling 7 is to be set up or established between the mobile terminal device 8 and the field device 2A.

In the first step S1, the method can start with a detection of a couplable pair of a field device 2A and a mobile terminal device 8. For this purpose, the mobile terminal device 8 can identify the couplable field device 2A.

In FIG. 2, a checkbox is used as an example to symbolize that the coupling readiness 11 of the field device 2A is present. In particular, the radio interface 4C of the field device 2C is therefore ready to set up or establish the wireless data connection 9 to the mobile terminal device 8 and/or the radio interface 8B thereof by means of the coupling 7.

The terminal device 8 can continuously search for field devices 2A, 2B, 2C with a coupling readiness 11 and/or the field device 2A, 2B, 2C can continuously search for terminal devices 8 with a coupling readiness. If a couplable field device 2A and/or terminal device 8 has/have been found, the coupling 7 is carried out fully automatically. However, the coupling 7 can optionally be performed or not performed or canceled/terminated depending on conditions, as explained in more detail below.

Optionally, but preferably, a verification requirement 12 is checked. The verification requirement 12 indicates/specifies whether a verification of the field device 2A should currently be performed.

If the checking of the verification requirement 12 is provided, the forming of the verification information 6, the coupling 7, the transmission of the verification information 6 and/or an/the evaluation of the verification information 6 for the purpose of verification is/are preferably performed only if the verification requirement 12 is checked and fulfilled.

The verification requirement 12 is preferably fulfilled or fulfillable if the verification requirement 12 is present on the basis of information for checking, in particular if a marking 13 assigned to the field device 2A is present and/or the current (point in) time 14 falls within a verification interval 15 assigned to the field device 2A.

In this way, it can be checked, preferably by the mobile terminal device 8, whether the field device 2A should be verified at the current point in time 14. For this purpose, information can be stored which states that the field device 2A should be verified. For example, a marking 13 can be present, symbolized in FIG. 2 by a checkbox, wherein the verification requirement 12 is fulfilled or fulfillable if the marking 13 assigned to the field device 2A is present.

Alternatively or additionally, one or more verification intervals 15 (time intervals) can be or are defined. In this case, the verification requirement 12 is fulfilled or fulfillable if the current point in time 14 falls within a verification interval 15 assigned to the field device 2A. This is also indicated in step S1 in FIG. 2.

The marking 13 and/or the verification interval 15 are assigned to the field device 2A and therefore illustrated in the region of the field device 2A in FIG. 2. The marking 13 and/or the verification interval 15 can be stored in the field device 2A. Alternatively or additionally, however, it is possible and preferred for the marking 13 and/or the verification interval 15 to be present in the mobile terminal device 8 or to be determined thereby.

An external application A may be provided, which is coupled to the terminal device 8 data-wise, for example via a mobile network or cellular network and/or the Internet. The external application A is in particular a server application and/or (Internet) cloud application. The application A may be or comprise a data platform. The external application A is preferably a central means/facility for or central to all terminal devices 8 if a plurality of terminal devices 8 are provided.

The application A may receive, evaluate and/or archive verification information 6. In particular, it can consolidate verification information 6 and/or combine/merge verification information 6 from different points in time as well as generate forecasts/predictions on this basis. Alternatively or additionally, the application A controls the verification process, preferably via the terminal device 8 or the terminal devices 8.

By means of the application A, it can be determined whether the verification requirement 12 is fulfilled for the field device 2A. For this purpose, the marking 13 and/or the verification interval 15 can be stored in the application A. Field devices 2A can thus be or become marked as “to be tested” in the application A.

Then, the mobile terminal device 8 can check the verification requirement 12 with the application A. For example, the terminal device 8 determines a field device ID 23 of the field device 2A, transmits said ID to the application A and receives from the application A the information as to whether the verification requirement 12 is fulfilled.

The marking 13 and/or the verification interval 15 can be or are defined per field device 2A and/or in the application A, for example repetitively like “as often as possible” or once per hour/day/ . . . )

The verification interval 15 can start after a phase in which a verification is not possible or necessary and/or the verification requirement 12 is not fulfilled. The verification interval 15 can result, for example, from legal or operational boundary conditions and/or from system-, plant- or field-device-specific boundary conditions such as an availability of the verification information 6.

The verification interval 15 is preferably reset on completion of a verification. In particular, on completion of a verification, the phase is started in which a verification is not possible or necessary and/or the verification requirement 12 is not fulfilled, and on expiry of this phase, the next verification interval 15 starts.

In the verification interval 15, while the field device 2A is marked and/or during the coupling 7, a self-test of the field device 2A, in particular a level 1 test (with uninterrupted measurement by the field device 2A), is preferably started. The self-test of the field device 2A can be triggered (automatically) during or after the coupling 7. This enables the automated testing of field devices 2A, in particular of those which are installed in batching applications.

If the field device 2A supports a level 2 test (with interrupted measurement of the field device 2A), a self-test of the field device 2A of the level 2 can also be started alternatively or additionally in the verification interval 15 and/or while the field device 2A is marked, during or after the coupling 7.

In a particularly advantageous embodiment of the present invention, the verification requirement 12 results taking into account a coupling probability with which a further coupling 7 or couplability (coupling capability) of the field device 2A with a/the terminal device 8 located in its reception range 10 is to be expected later in the verification interval 15.

The verification requirement 12 can be fulfilled or fulfillable if a checking of a remaining duration of the verification interval 15 (between the current point in time 14 and the end of the verification interval 15) results in the coupling probability being too small and/or being below a certain threshold.

If the coupling probability in the remaining duration of the verification interval 15 is sufficiently large and/or is above the threshold, a verification (coupling 7/self-test of the field device 2A) can be dispensed with at the current point in time 14 and the verification can be carried out accordingly at a later point in time of the verification interval 15.

For example, after detection of a field device 2A, the mobile terminal device 8 sends a pairing notification corresponding to the field device 2A and/or a request for the verification requirement 12 for the field device 2A to the application A. Based on or using the pairing notification and/or request, the application A checks with what probability a further coupling 7 will occur within the verification interval 15 and instructs the mobile terminal device 8 to start further steps for verification and/or the self-test of the field device 2A only if the verification interval 15 is likely to be left before the next coupling 7.

Example 1: A verification is desired every 12 hours, the last verification took place 8 hours ago, a mobile terminal device 8 is moved past the field device 2A approximately every 30 minutes→Do not start a new verification yet

Example 2: A verification is desired every 12 hours, the last verification took place 8 hours ago, a mobile terminal device 8 is moved past the field device 2A approximately every 300 minutes→Start a new verification

Example 3: A verification is desired every 12 hours, the last verification took place 8 hours ago, a mobile terminal device 8 is moved past the field device 2A to be verified approximately every 30 minutes, but the verification interval 15 ends prematurely, for example when it is 5 p.m., the shift ends and there is no night shift→Start a new verification

The coupling 7 takes place and/or the wireless data connection 9 is set up or established in the second step S2, preferably if there is coupling readiness 11 of the field device 2A and the verification requirement 12 has been checked and is fulfilled. However, the coupling 7 can also take place first before the verification requirement 12 is checked.

Forming of the verification information 6 or of parts of the verification information 6 can take place continuously or during ongoing operation of the field device 2A, via a time control at one or more predefined points in time and/or via an event control, for example depending on certain boundary conditions such as a monitored measurement behavior of the sensor 5.

In principle, it can thus be provided that the verification information 6 is already present/available at the point in time of the coupling 7. This can be the case if the verification information 6 is formed continuously or on an ongoing basis. For this purpose, the field device 2A can carry out one or more self-tests or other parts of the verification including forming of the verification information 6 independently (in the background) even without coupling 7.

The verification information 6 can be stored and/or buffered (temporarily stored) in a device memory 18 of the field device 2A. The verification information 6 held available and/or (temporarily) stored in the device memory 18 can be transmitted by the field device 2A during or after the coupling 7, in particular can be sent by the field device 2A or can be accessed/retrieved/read out by the mobile terminal device 8. In this case, the verification information 6 is preferably transmitted via the data connection 9.

In contrast, in the illustrative example according to FIG. 2, a self-test control command 16 is transmitted from the terminal device 8 to the field device 2A via the data connection 9. This is illustrated in step S3 in FIG. 2. Upon receipt of the self-test control command 16 by the field device 2A, the field device 2A can carry out a self-test and thereby form the verification information 6.

As indicated in FIG. 2 in step S4 with a clock symbol, the transmission of the self-test control command 16 via the data connection 9 can be followed by a waiting time 17 while the verification information 6 is generated.

In the illustrative example according to FIG. 2, the verification information 6 is transmitted from the field device 2A to the mobile terminal device 8 via the existing data connection 9. Alternatively or additionally, it is possible for the verification information 6 to be transmitted to the application A via the mobile terminal device 8. In principle, this transmission can also take place independently of the mobile terminal device 8.

The terminal device 8 can fulfill the function of a bridge, gateway or router between the field device 2A and other components such as the application A. The terminal device 8 can thus receive the verification information 6 via the wireless data connection 9 and forward it via another medium or network such as a mobile network and/or the Internet, preferably to the application A.

As schematically indicated in step S5 of FIG. 2, the verification information 6 may comprise raw data 21, a time stamp 22 and/or a field device ID 23. The raw data 21 in turn contain information which enables the verification of the field device function. In particular, these are parameters which represent the operation or a self-test result of the field device 2A.

The verification information 6 is preferably evaluated. This can take place in the mobile terminal device 8. Alternatively or additionally, the verification information 6 can be transmitted to the external application A, which in turn effects/causes the evaluation of the verification information 6.

The verification information 6 is preferably evaluated with regard to the state of the field device 2A, with regard to a process carried out with the field device 2A, and/or to predict possible failures or failure probabilities of the field device 2A.

In this way, current raw data 21 or data derived therefrom, for example aggregated data, can be compared with corresponding historical data 19, over time series and/or with reference values and/or threshold values. Alternatively or additionally, change trends can be determined based on the raw data 21 and/or the data derived therefrom.

In one aspect of the present invention, a prediction or forecast of the field device function is created. Based on or using the prediction/forecast, it can be assessed/evaluated whether a defect is foreseeable and/or probable. Accordingly, maintenance, repair or replacement can be carried out before the defect occurs.

The prediction/forecast can be generated on the basis of the raw data 21, the data derived therefrom and/or change trends. In principle, however, also another form of evaluation of the verification information 6 can be used for the prediction/forecast.

In particular, a prediction/forecast of possible failures or failure probabilities of the field device 2A is made on the basis of historical data 19, in particular one or more time series, wherein the historical data 19, in particular the one or more time series, correspond to the raw data 21, the data derived therefrom and/or change trends at one or more earlier points in time.

In one aspect of the present invention, raw data 21 or parts thereof are generated at multiple, different, consecutive points in time and a/the time series is formed directly from these or from data derived therefrom. The time stamp 22 and/or the field device ID 23 can be used for this purpose, which is not mandatory, however.

A verification result 24 can represent whether the verification was successful, i.e. whether the evaluation of the verification information 6 has resulted in the field device function having no irregularities such as an indication of an existing or imminent or soon defect. The verification result 24 can be or comprise details about the function of the field device 2A such as an accuracy information or tolerance information, a prediction about the function of the field device according to specification or not according to specification, and/or a recommendation for action relating to the field device 2A.

As indicated in step S6 in FIG. 2, the verification information 6 or the verification result 24 formed by the evaluation thereof can be sent to the (external) application A. Particularly preferably, the application A receives the verification information 6 and analyzes it for forming the verification result 24.

The mobile terminal device 8 can establish a connection between the field device 2A and the Internet, via which a data connection to the application A exists. However, it is alternatively or additionally possible for the application A to be executed on the mobile terminal device 8.

Forming of the verification information 6, the coupling 7, the transmission of the verification information 6 and/or the evaluation of the verification information 6 for the purpose of verification is/are preferably one or more background activities. In particular, these are processes which are executed on the mobile terminal device 8, the field device 2A and/or the application A without this requiring a user intervention.

In this respect, it is preferred that the background activities also and especially in the case of a terminal device 8 carry out the proposed method fully automatically, while the user interface of the mobile terminal device 8, which may be formed by the touch-sensitive display means 8A, is locked/blocked against registration and/or processing of inputs.

It is therefore preferred that the locked mobile terminal device 8 carries out the steps necessary for the coupling 7 fully automatically, whereupon the verification information 6 is transmitted-whether by transmitting the self-test control command 16 from the mobile terminal device 8 to the field device 2A or by retrieving verification information 6 already stored in the field device 2A. Also the evaluation of the verification information 6 and/or forming of the verification result 24 and/or forming of time series is/are preferably performed fully automatically and/or as background activities.

The data connection 9 is preferably automatically disconnected when the verification information 6 has been transmitted fully or partially and/or when the mobile terminal device 8 leaves the reception range 10. If the verification information 6 has not yet been transmitted (fully) by the time the data connection 9 is disconnected, this is preferably carried out/completed on a next coupling 7 of the or another mobile terminal device 8 with the same field device 2A.

At this point, it should be emphasized once again that the described aspects of the present invention preferably apply correspondingly to other of the field devices 2A, 2B, 2C and/or other mobile terminal devices 8. In particular, therefore, with regard to the described aspects, the field device 2A can be supplemented or replaced by one or more other field devices 2B, 2C.

When the mobile terminal device 8 reaches or enters a (different/further) reception range 10 of the different field devices 2A, 2B, 2C, the aspects described in connection with the field device 2A on the basis of FIG. 2 preferably also apply correspondingly to the other of the field devices 2A, 2B, 2C.

As indicated in FIG. 1 by the dashed arrow, the mobile terminal device 8 is preferably moved relative to the field device(s) 2A, 2B, 2C. During the movement 20, the coupling 7 then takes place automatically and/or the verification information 6 is automatically transmitted during the movement 20 via the wireless data connection 9 from the respective field device 2A, 2B, 2C.

Particularly preferably, the mobile terminal device 8 successively reaches or enters reception ranges 10 of different ones of the field devices 2A, 2B, 2C as a result of the movement 20 relative to the field devices 2A, 2B, 2C, so that the respective verification information 6 of the respective one of the different field devices 2A, 2B, 2C is transmitted and the verification of the respective one of the different field devices 2A, 2B, 2C can take place on this basis.

In one example, the mobile terminal device(s) 8 is or are moved in the region of a plant/installation/facility and/or of a system 1 comprising field devices 2A, 2B, 2C. Meanwhile, the mobile terminal device 8 searches in the background/without user intervention for couplable field devices 2A, 2B, 2C, for example with BLE connectivity. As soon as such a field device 2A, 2B, 2C has been found, the mobile terminal device 8 carries out an automated pairing, i.e. a coupling 7 with the respective one of the field devices 2A, 2B, 2C. In this case, one or more of the following steps are preferably carried out:
The mobile terminal device 8 sends a pairing notification to the application A, wherein the pairing notification may comprise the field device ID and/or the current point in time.
The mobile terminal device 8 checks the device memory 18 of the coupled one of the field devices 2A, 2B, 2C for existing verification information 6 and downloads it from the field device 2A, 2B, 2C, preferably into the application A.
The mobile terminal device 8 checks with the aid of the application A the necessity and possibility of a (new) verification.
The mobile terminal device 8 sends a time stamp 22 to the field device 2A, 2B, 2C and/or to the application A as required and in particular for clock synchronization and starts the verification for the field device 2A, 2B, 2C.
The mobile terminal device 8 is moved further, which leads to a disconnection of the coupling 7, and/or the coupling 7 is automatically disconnected.
The application A optionally generates a check certificate from the verification information 6 or the verification result 24 and forwards it as required or outputs it.

If field devices 2A, 2B, 2C do not have a real-time clock, they receive the current point in time 14 and/or the verification interval 15 via the mobile terminal device 8 as required (reconfiguration during coupling 7).

During the coupling 7, preferably only the respective current verification information 6 is downloaded from the field device 2A, 2B, 2C and, as required, uploaded into the application A.

In a further aspect of the present invention, the verification information 6 is transmitted in a distributed manner via multiple chronologically successive couplings 7 of the field device 2A, 2B, 2C with the same or different terminal devices 8.

It can thus be provided that the period in which the mobile terminal device 8 is located in the reception range 10 of the respective field device 2A, 2B, 2C is not sufficient to transmit the verification information 6 fully. In these cases, it is preferred that a partial or stepwise transmission of the verification information 6 takes place via multiple couplings 7, possibly even with different mobile terminal devices 8. The complete verification information 6 can then be assembled or put together, for example by the application A.

In other words, the verification information 6 can be transmitted to the application A in fragmented form and within multiple couplings 7 when, during the transmission of the verification information 6 and/or during the self-test, the terminal device 8 leaves the reception range 10 (reception radius) of the field device 2A, 2B, 2C too quickly again.

With the present invention, in summary, field device functions of multiple different field devices 2A, 2B, 2C can advantageously be verified in an incidental manner without user intervention on the basis of the proposed method implemented as background activity, wherein the mobile terminal device 8 is moved and thereby reaches (randomly/incidentally) reception ranges 10 of the different field devices 2A, 2B, 2C, wherein the coupling 7 of the mobile terminal device 8 with the respective one of the different field devices 2A, 2B, 2C takes place fully automatically, whereupon the generation and/or the retrieval of the verification information 6 of the respective field device 2A, 2B, 2C and the evaluation of the verification information 6 and, with the verification information 6, the verification of the field device function of the respective field device 2A, 2B, 2C is effected/caused by deriving a verification result 24 for the respective field device 2A, 2B, 2C from the verification information 6.

The proposed method is preferably used in or applied to the proposed system 1 with at least one terminal device 8 and multiple field devices 2A, 2B, 2C, which system is configured to carry out the proposed method. In the system 1, the field devices 2A, 2B, 2C and the mobile terminal device(s) 8 are thus preferably configured so as to correspond to one another such that the verification can be carried out with the method according to the present invention.

Particularly preferably, a background process is executed on the processor 8C of the mobile terminal device 8, which background process is configured to recognize/detect a field device 2A, 2B, 2C when its reception range 10 is reached/entered and thereupon to effect the proposed coupling 7.

Furthermore, the background process is preferably configured to send the self-test control command 16 to the coupled field device 2A, 2B, 2C and to receive as a response the verification information 6, which can then be evaluated, also without user input. For this purpose, the terminal device 8 can perform the evaluation of the verification information 6 and/or forward the verification information 6 to the application A, which then performs the evaluation.

The transmission of the verification information 6 for verifying the field device function of the respective field device 2A, 2B, 2C is enabled on the field devices 2A, 2B, 2C.

Background processes are preferably provided both on the (respective) field device 2A, 2B, 2C and on the mobile terminal device(s) 8, which background processes enable the proposed coupling 7 and/or the transmission of the verification information 6 for verifying the field device function of the respective field device 2A, 2B, 2C fully automatically without user intervention.

Furthermore, a computer program product 25 is preferably provided, which comprises program code means, which, when executed on processors 4D, 8C of the field device 2A, 2B, 2C and of the terminal device(s) 8 of the system 1, effect/cause the execution of the steps of the proposed method.

The program code means are preferably stored—preferably non-volatilely or non-transitory—on the device memory 18 of the (respective) field device 2A, 2B, 2C and/or a terminal device memory 26 of the mobile terminal device 8. The program code means can be read out and executed on the processor 8C of the mobile terminal device 8 and/or the processor 4D of the respective field device 2A, 2B, 2C for the purpose of carrying out the proposed method.

Individual aspects of the present invention can be implemented separately from one another and/or combined with one another in different ways and thereby have a synergistic effect and/or be advantageous, even if this is not explicitly explained.

The present invention relates in particular to any one of the following aspects which can be implemented independently or in any combination, also in any combination with the aspects above:
1. Method for verifying a field device function of a field device 2A, 2B, 2C, preferably during an uninterrupted connection of a measuring transducer 4 to a sensor 5 of the field device 2,
wherein the field device 2A, 2B, 2C forms verification information 6 with which the field device function is verifiable,
wherein a coupling 7 takes place between a mobile terminal device 8 and the field device 2A, 2B, 2C, as a result of which a wireless data connection 9 is set up between the field device 2A, 2B, 2C and the mobile terminal device 8, and
wherein the verification information 6 is transmitted via the wireless data connection 9 from the field device 2A, 2B, 2C and the field device function of the field device 2A, 2B, 2C is verified with the verification information 6, characterized
in that the coupling 7 takes place fully automatically when the mobile terminal device 8 reaches a reception range of the field device 2A, 2B, 2C, and in that the verification information 6 is transmitted fully automatically from the field device 2A, 2B, 2C via the wireless data connection 9.
2. Method according to Aspect 1, characterized in that the mobile terminal device 8 continuously searches for field devices 2A, 2B, 2C with a coupling readiness 11 or the field device 2A, 2B, 2C continuously searches for mobile terminal devices 8 with a coupling readiness 11 and, if such a field device 2A, 2B, 2C and/or mobile terminal device 8 has been found, the coupling 7 is carried out fully automatically.
3. Method according to Aspect 1 or 2, characterized in that forming the verification information 6, the coupling 7, the transmission of the verification information 6 and/or an evaluation of the verification information 6 for the purpose of verification is/are one or more background activities.
4. Method according to one of the preceding aspects, characterized in that forming the verification information 6, the coupling 7, the transmission of the verification information 6 and/or an/the evaluation of the verification information 6 for the purpose of verification is/are performed if a verification requirement 12 is checked and fulfilled.
5. Method according to Aspect 4, characterized in that the verification requirement 12 is fulfilled or fulfillable if a marking 13 assigned to the field device 2A, 2B, 2C is present and/or the current point in time 14 falls within a verification interval 15 assigned to the field device 2A, 2B, 2C.
6. Method according to Aspect 5, characterized in that the verification requirement 12 takes into account a couplability probability with which a further couplability of the field device 2A, 2B, 2C with a/the mobile terminal device 8 located in the range of the field device 2A, 2B, 2C is to be expected later in the verification interval 15.
7. Method according to one of the preceding aspects, characterized in that forming the verification information 6 is performed by a self-test carried out by the field device 2A, 2B, 2C and/or is initiated via a time control and/or via an event control and/or via the wireless data connection 9.
8. Method according to one of the preceding aspects, characterized in that the verification information 6 is temporarily stored in a device memory 18 of the field device 2A, 2B, 2C, wherein the verification information 6 stored in the device memory 18 is read out from the device memory 18 during coupling 7 of the field device 2A, 2B, 2C with the mobile terminal device 8 and is transmitted via the wireless data connection 9.
9. Method according to one of the preceding aspects, characterized in that the verification information 6 is evaluated with regard to the state of the field device 2A, 2B, 2C, with regard to a process carried out with the field device 2A, 2B, 2C, and/or to predict possible failures or failure probabilities of the field device 2A, 2B, 2C, preferably on the basis of historical data 19, in particular time series.
10. Method according to one of the preceding aspects, characterized in that the mobile terminal device 8 is moved relative to the field device 2A, 2B, 2C and the coupling 7 takes place automatically during the movement 20 and/or the verification information 6 is transmitted automatically from the field device 2A, 2B, 2C via the wireless data connection 9 during the movement 20.
11. Method according to one of the preceding aspects, characterized in that the verification information 6 is transmitted in a distributed manner via multiple chronologically successive couplings 7 of the field device 2A, 2B, 2C with the same or different mobile terminal devices 8.
12. Method according to one of the preceding aspects, characterized in that the verification information 6 comprises raw data 21, an assigned time stamp 22 and/or a field device ID 23 of the field device 2, and/or
in that a verification result 24 is formed by evaluation of the verification information 6, preferably wherein the verification information 6 is received and evaluated by a preferably cloud-based application A, in particular data platform, and/or
in that the wireless data connection 9 is automatically disconnected after the complete or partial transmission of the verification information 6.
13. Method according to one of the preceding aspects, characterized in that the field device function of multiple field devices 2A, 2B, 2C is respectively verified with the method according to one of the preceding aspects.
14. System 1 comprising at least one mobile terminal device 8 and at least one field device 2A, 2B, 2C, wherein the system 1 is configured to carry out the method according to one of the preceding aspects.
15. Computer program product 25 comprising program code means, which, when executed on processors 4D, 8C of the field device 2A, 2B, 2C and of the mobile terminal device 8 of the system 1 according to Aspect 14, cause the method according to one of Aspects 1 to 13 to be carried out.

List of reference signs:

| | |
|---|---|
| 1 | System |
| 2A | Field device |
| 2B | Field device |
| 2C | Field device |
| 3 | Connection |
| 4 | Measuring transducer |
| 4A | Display means |
| 4B | Interface |
| 4C | Radio Interface |
| 4D | Processor |
| 5 | Sensor |
| 6 | Verification information |
| 7 | Coupling |
| 8 | Mobile terminal device |
| 8A | Display means |
| 8B | Radio Interface |
| 8C | Processor |
| 9 | Wireless data connection |
| 10 | Reception range |
| 11 | Coupling readiness |
| 12 | Verification requirement |
| 13 | Marking |
| 14 | Point in time |
| 15 | Verification interval |
| 16 | Self-test control command |
| 17 | Waiting time |
| 18 | Device memory |
| 19 | Historical data |
| 20 | Movement |
| 21 | Raw data |
| 22 | Time stamp |
| 23 | Field device ID |
| 24 | Verification result |
| 25 | Computer program product |
| 26 | Terminal device memory |
| A | Application |
| t | Time |
| S1 | First step |
| S2 | Second step |
| S3 | Third step |
| S4 | Fourth step |
| S5 | Fifth step |
| S6 | Sixth step |

What is claimed is:

1. A method for verifying a field device function of a field device, comprising:
the field device forming verification information with which the field device function is verifiable,
carrying out a coupling between a mobile terminal device and the field device, as a result of which a wireless data connection is set up between the field device and the mobile terminal device, the coupling taking place fully automatically when the mobile terminal device enters a reception range of the field device, and
fully automatically transmitting the verification information via the wireless data connection from the field device and verifying the field device function of the field device with the verification information.

2. The method according to claim 1, wherein the method comprises performing the verification of the field device function of the field device during an uninterrupted connection of a measuring transducer to a sensor of the field device.

3. The method according to claim 1, wherein the mobile terminal device continuously searches for field devices with a coupling readiness or the field device continuously searches for mobile terminal devices with a coupling readiness and, if such a field device and/or mobile terminal device has been found, the coupling is carried out fully automatically.

4. The method according to claim 1, wherein forming the verification information, the coupling, the transmission of the verification information and/or an evaluation of the verification information for the purpose of verification is/are one or more background activities.

5. The method according to claim 1, further comprising checking that a verification requirement is fulfilled, and performing the forming of the verification information, the coupling, the transmission of the verification information and/or an evaluation of the verification information for the purpose of verification since the verification requirement is fulfilled.

6. The method according to claim 5, further comprising checking for a second field device that the verification requirement is not fulfilled, as a result of which no verification of a second field device function of the second field device, no external triggering of forming verification information, no coupling, no transmission of verification information and/or no evaluation of verification information for the purpose of verification is performed.

7. The method according to claim 5, wherein checking that the verification requirement is fulfilled comprises checking if a marking assigned to the field device is present and/or the current point in time falls within a verification interval assigned to the field device.

8. The method according to claim 5, wherein the verification requirement takes into account a couplability probability with which a further couplability of the field device with a/the mobile terminal device located in the range of the field device is to be expected later in the verification interval.

9. The method according to claim 7, wherein the verification requirement takes into account a couplability probability with which a further couplability of the field device with a/the mobile terminal device located in the range of the field device is to be expected later in the verification interval.

10. The method according to claim 1, wherein forming the verification information is performed by a self-test carried out by the field device and/or is initiated via a time control and/or via an event control and/or via the wireless data connection.

11. The method according to claim 1, further comprising temporarily storing the verification information in a device memory of the field device, reading out the verification information stored in the device memory from the device memory during coupling of the field device with the mobile terminal device and transmitting the verification information via the wireless data connection.

12. The method according to claim 1, further comprising evaluating the verification information with regard to the state of the field device, with regard to a process carried out with the field device, and/or to predict possible failures or failure probabilities of the field device.

13. The method according to claim 1, further comprising moving the mobile terminal device relative to the field device and automatically carrying out the coupling during the movement and/or automatically transmitting the verification information from the field device via the wireless data connection during the movement.

14. The method according to claim 1, further comprising transmitting the verification information in a distributed manner via multiple chronologically successive couplings of the field device with the same or different mobile terminal devices.

15. The method according to claim 1, wherein the verification information comprises raw data, an assigned time stamp and/or a field device ID of the field device.

16. The method according to claim 1, further comprising receiving and evaluating the verification information by an application stored on the terminal device or an external server, by a cloud-based application, or by a data platform, and forming a verification result by evaluation of the verification information.

17. The method according to claim 1, further comprising automatically disconnecting the wireless data connection after the complete or partial transmission of the verification information.

18. The method according to claim 1, further comprising verifying a second field device function of a second field device by means of the following steps:
the second field device forming second field device verification information with which the second field device function is verifiable,
carrying out a coupling between the mobile terminal device or a different mobile terminal device and the second field device, as a result of which a wireless data connection is set up between the second field device and the mobile terminal device, the coupling taking place fully automatically when the mobile terminal device enters a reception range of the second field device, and
fully automatically transmitting the second field device verification information via the wireless data connection from the second field device and verifying the second field device function of the second field device with the second field device verification information.

19. A system comprising at least one mobile terminal device and at least one field device, the system comprising means for:
forming verification information by the field device with which the field device function is verifiable,
carrying out a coupling between a mobile terminal device and the field device, as a result of which a wireless data connection is set up between the field device and the mobile terminal device, the coupling taking place fully automatically when the mobile terminal device enters a reception range of the field device, and
fully automatically transmitting the verification information via the wireless data connection from the field device and verifying the field device function of the field device with the verification information.

20. A non-transitory computer-readable storage medium comprising program code means, which, when executed on processors of a field device and of a mobile terminal device perform the steps of:
carrying out a coupling between a mobile terminal device and the field device, as a result of which a wireless data connection is set up between the field device and the mobile terminal device, the coupling taking place fully automatically when the mobile terminal device enters a reception range of the field device, and
fully automatically transmitting verification information formed by the field device via the wireless data connection from the field device and verifying the field device function of the field device with the verification information.
